(19) United States
(12) Patent Application Publication
(10) Pub. No.: US 2009/0103006 A1
(43) Pub. Date: Apr. 23, 2009

(54) Backlight assembly and liquid crystal display device using the same

(75) Inventors: Michel Cadio, Carmel, IN (US); Estill Thone Hall, JR., Fishers, IN (US); Brent Hoffman, Mooresville, IN (US)

Correspondence Address: MORGAN LEWIS & BOCKIUS LLP, 1111 PENNSYLVANIA AVENUE NW, WASHINGTON, DC, 20004, US

(73) Assignee: TTE Indianapolis, Indianapolis, IN (US)

(21) Appl. No.: 11/907,786

(22) Filed: Oct. 17, 2007

(51) Int. Cl. G02F 1/13357; F21V 8/00

(52) U.S. Cl. 349/64; 362/616

(57) ABSTRACT

A liquid crystal display (LCD) device includes an LCD panel having an exterior surface with a first area and an interior surface; a light filter layer having an exterior surface provided at the interior surface of the LCD panel and an interior surface; a light guide assembly provided behind the interior surface of the light filter layer, the light guide assembly including a plurality of light pipes; a light source including a plurality of selectively illuminated lamps arranged at a lateral side of the light guide assembly, each of the lamps being respectively associated with a different one of the light pipes for emitting light into the respective light pipe; a plurality of diffusion surfaces, each of the diffusion surfaces being provided on a selected area of a respective one of the plurality of the light pipes, the selected area being smaller than the first area; wherein each of the diffusion surfaces causes light to be emitted from the selected area of the respective light pipe when the light pipe is illuminated by the lamp associated therewith.

### BACKGROUND OF THE INVENTION

1. Field of the Invention

The present invention relates to a backlight assembly and a display device using the same, and more particularly, to a backlight assembly for a thin portable liquid crystal display (LCD) device, which is capable of selectively lighting up different screen areas of the portable LCD device without increasing the thickness of the portable LCD device.

2. Discussion of the Related Art

With rapid development of information technology, flat panel display devices are in great demand because of their superior characteristics such as thin profile, light weight, and low power consumption. Among those flat panel display devices, liquid crystal display (LCD) devices having excellent color reproduction are being aggressively researched and developed.

The LCD device includes an LCD panel having a thin film transistor (TFT) substrate, a color filter substrate and a liquid crystal layer disposed therebetween. Since the LCD panel does not emit light by itself, the LCD device includes a backlight assembly at a rear side of the LCD panel as a light source for providing light. The transmittance of the light generated from the backlight assembly is adjusted according to an alignment of the liquid crystal layer. The LCD panel and the backlight assembly are accommodated in a chassis of the LCD device. Depending on a location of the light source, the backlight assembly may be classified as an edge-type or direct-type backlight assembly. The edge-type backlight assembly is provided with a light source at a lateral side of a light guiding plate and is typically used for relatively small sized LCDs. The edge-type backlight assembly provides high light uniformity and good endurance and is suitable for use in thin profile LCDs, such as lap tops, portable TVs and DVD players.

Hereinafter, an LCD device with a backlight assembly according to the related art will be described with reference to FIGS. 1 and 2. FIG. 1 is a view schematically illustrating a related art LCD device 1, and FIG. 2 schematically illustrates a vertical section of the related art LCD device 1 of FIG. 1. Referring to FIGS. 1 and 2, the related art LCD device 1 includes an LCD panel 10, a light filter layer 20 arranged behind the LCD panel 10, a light guide plate 30 arranged behind the light filter layer 20, and a light source 40 arranged laterally at the side of the light guide plate 30. The light guide plate 30 may have a thickness usually from 2 mm to more than 10 mm. The light guide plate 30 may be made of a transparent plastic material. The light source 40 may include one or a plurality of lamps.

As shown in FIG. 2, there are a plurality of diffusion lines or surfaces 50 painted on a rear surface of the light guide plate 30. These diffusion lines or surfaces 50 serve to diffuse light, which is emitted from the light source 40 and then guided by the light pipes of the light guide plate 30. When the light source 40 turns ON to emit light beams 60 through the edge of the light guide plate 30, the light beams 60 bounce inside the light guide plate 30 until they hit the diffusion lines or surfaces 50 painted on the rear surface of the light guide plate 30. Some of the diffused light beams 60 will go through a front surface of the light guide plate 30 to be guided toward the LCD panel 10, when the angles between the light beams 60 and the perpendicular of the front surface are small enough. Moreover, the reference numeral 70 denotes that the light beams 60 make specular reflection inside the light guide plate 30.

The LCD panel 10 includes a plurality of the pixels (not shown) arranged in a matrix of rows (lines) and columns. The pixels are “refreshed” line by line. Since changing a pixel state from ON to OFF takes time, if the back light is ON at all time, it can cause some undesirable picture artifacts. For this reason, it would be good to turn off the light in the area of the screen of the LCD panel 10, in which the pixels are being “refreshed”.

It is also possible to create a software program in a TV using the LCD panel 10, which analyzes the image to decide if all areas of the picture need full brightness or if the back light for some areas can be turned off. This can be an energy saving feature for the TV, but it means that some lamps of the light source can be turned off independently of the other lamps.

In the direct-type backlight assembly, a light source is arranged right behind a screen of the LCD panel, and therefore can be designed and controlled to light up different parts of the screen of the LCD panel independently. However, this manner of mounting the light source in the direct-type backlight assembly may objectively increase the thickness of the LCD device, which is not desirable for portable LCD devices, such as lap tops, portable TVs, and the like. On the other hand, the related art LCD device using the edge-type backlight assembly cannot selectively illuminate areas of the screen of the LCD device.

### SUMMARY OF THE INVENTION

Accordingly, the present invention is directed to a backlight assembly and an LCD device using the same which substantially obviate one or more problems due to limitations and disadvantages of the related art.

An object of the present invention is to provide a backlight assembly for an LCD device, which is capable of selectively illuminating areas of the screen of the LCD device.

Another object of the present invention is to provide a backlight assembly for an LCD device, which is capable of selectively illuminating areas of the screen, thereby reducing or cancelling undesirable artifacts displayed on the screen of the LCD device.

Another object of the present invention is to provide a backlight assembly for an LCD device with a lower energy consumption by providing different lighting energy for different parts of the screen depending on the image contents displayed on the LCD device.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, the LCD device includes an LCD panel having an exterior surface with a first area and an interior surface, a light filter layer having an exterior surface provided at the interior surface of the LCD panel and an interior surface, a light guide assembly provided behind the interior surface of the light filter layer, the light guide assembly including a plurality of light pipes, a light source including a plurality of selectively illuminated lamps arranged at a lateral side of the light guide assembly, each of the lamps being respectively associated with a different one of the light pipes for emitting light into the respective light pipe, a plurality of diffusion surfaces, each of the diffusion surfaces being provided on a selected area of a respective one of the plurality of the light pipes, the selected area being smaller than the first area, wherein each of the diffusion surfaces causes light to be emitted from the selected area of the respective light pipe when the light pipe is illuminated by the lamp associated therewith.

In another aspect of the present invention, the backlight assembly for the LCD device includes a light guide assembly including a plurality of light pipes, a light source arranged at a lateral side of the light guide assembly, a plurality of diffusion surfaces, each of the diffusion surfaces being provided on a selected area of a respective one of the plurality of the light pipes, wherein each of the diffusion surfaces causes light to be emitted from the selected area of the respective light pipe when the light pipe is illuminated by the light source.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a view schematically illustrating a liquid crystal display (LCD) device having a backlight assembly according to the related art;

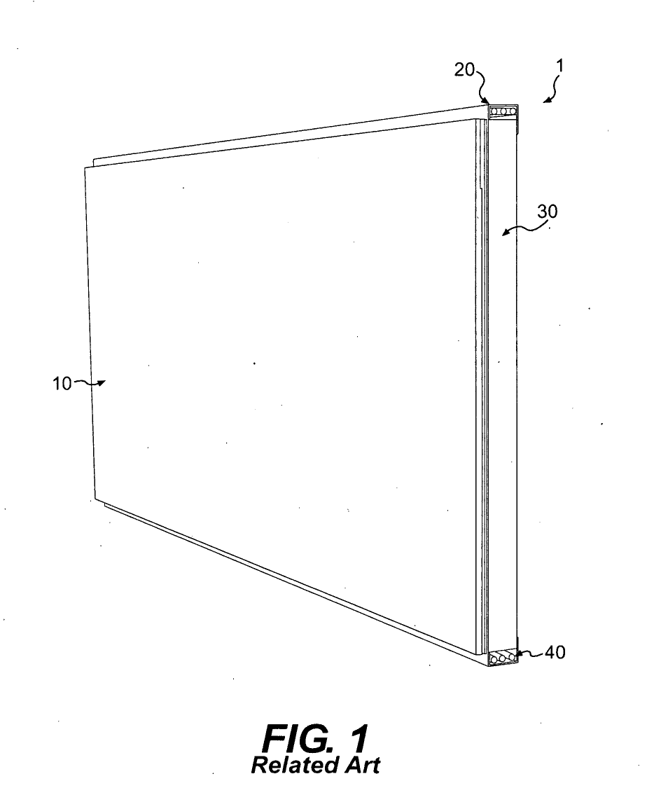

FIG. 2 schematically illustrates a vertical section of the related art LCD device of FIG. 1;

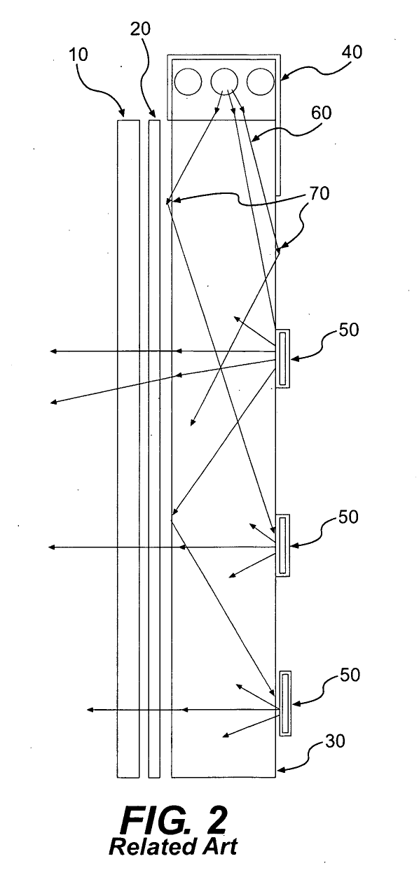

FIGS. 3(a) to 3(c) are cross-sectional views schematically illustrating an LCD device including a backlight assembly according to a first exemplary embodiment of the present invention;

FIG. 4 is a view schematically illustrating a light pipe configuration of the backlight assembly of the LCD device according to the first exemplary embodiment of the present invention;

FIG. 5 is a view schematically illustrating one light pipe of the backlight assembly of the LCD device according to the first embodiment of the present invention;

FIGS. 6(a) to 6(c) are cross-sectional views schematically illustrating an LCD device including a backlight assembly according to a second exemplary embodiment of the present invention;

FIG. 7 is a view schematically illustrating a light pipe configuration of the backlight assembly of the LCD device according to the second exemplary embodiment of the present invention;

FIG. 8 is a view schematically illustrating the light pipe configuration of the backlight assembly of the LCD device of FIG. 7 according to the second exemplary embodiment of the present invention; and

FIG. 9 is a view schematically illustrating the light pipe configuration of the backlight assembly of the LCD device of FIG. 7 according to the second exemplary embodiment of the present invention.

### DETAILED DESCRIPTION OF THE PREFERRED EMBODIMENTS

Reference will now be made in detail to the preferred embodiments of the present invention, examples of which are illustrated in the accompanying drawings.

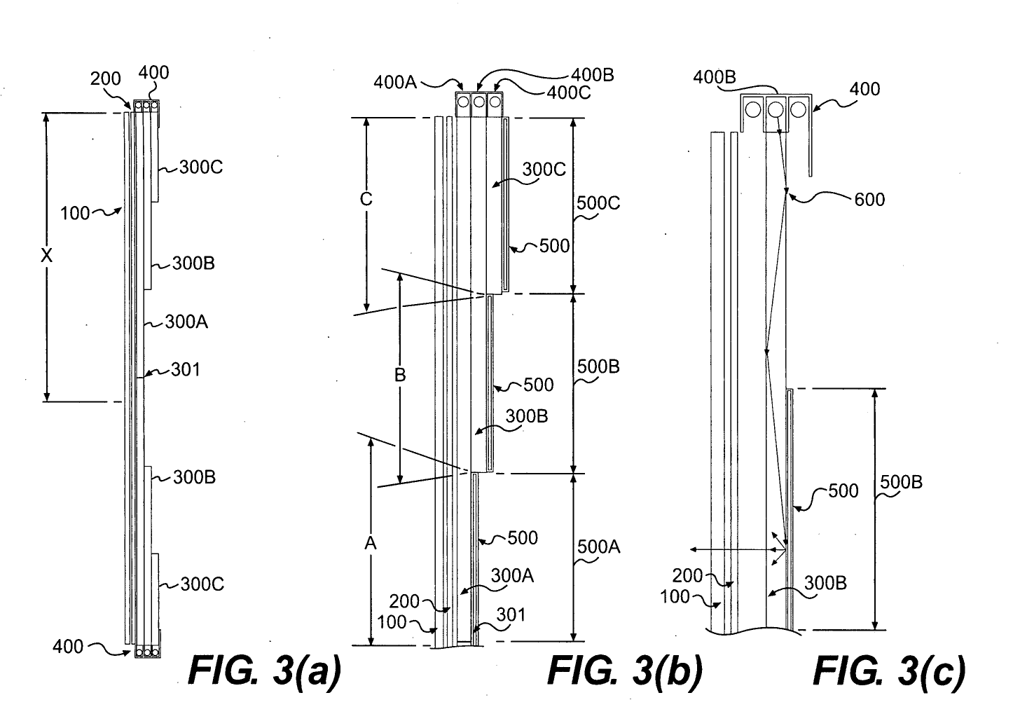

FIGS. 3(a) to 3(c) are cross-sectional views schematically illustrating an LCD device including a backlight assembly according to a first exemplary embodiment of the present invention. FIG. 3(a) is a cross-sectional view illustrating the backlight assembly including a plurality of light pipes with different lengths, FIG. 3(b) is a cross-sectional view illustrating a portion X of the backlight assembly of FIG. 3(a), and FIG. 3(c) is a cross-sectional view illustrating one light pipe of the backlight assembly of the LCD device of FIG. 3(b).

Referring to FIGS. 3(a) to 3(c), the LCD device of the first exemplary embodiment includes an LCD panel 100, a light filter layer 200 arranged behind the LCD panel 100, and the backlight assembly arranged behind the light filter layer 200. The backlight assembly includes a light guide plate 300 arranged behind the light filter layer 200, and a light source 400 arranged laterally at two sides of the light guide plate 300. The light guide plate 300 may include a plurality of light pipes, which are stacked together, thereby forming the light guide plate 300. The light pipes may be made of a transparent plastic material. The light source 40 includes a plurality of lamps. The light pipes are designed to have different configurations. That is, the light pipes may be formed with different lengths, thicknesses or shapes depending on image contents to be displayed. Also, the plurality of lamps may be provided with different types and powers depending on the image contents to be displayed or the light pipes with which they are associated.

As shown in FIG. 3(b), which corresponds to the portion X of FIG. 3(a), in this exemplary embodiment, there are three light pipes 300A, 300B and 300C, and three lamps 400A, 400B and 400C that respectively correspond to the light pipes 300A, 300B and 300C of the light guide plate 300. The light pipes 300A, 300B and 300C may be formed at least with different lengths. The lamps 400A, 400B and 400C may be provided with different powers. Each light pipe has at least a portion thereof covered by a diffusion surface 500. The diffusion surface 500 may be made of white paint, white line, or a surface texture of the light pipe. The diffusion surface 500 may also be made of any other materials that allow the diffusion of light. Because each of the light pipes 300A, 300B and 300C has at least a portion of its rear surface covered by the diffusion surface 500, the covered portion serves to illuminate the LCD panel 100. Moreover, the diffusion surfaces 500 covered on the different light pipes may be formed with different configurations, for example, different shapes and thicknesses.

In the first exemplary embodiment, as shown in FIG. 3(a), the light guide plate 300 includes an upper part and a lower part, which are symmetrical about the center of the LCD panel 100, or a center 301 of the light pipe 300A, such that each of the upper and lower parts includes the light pipes 300A, 300B and 300C of different lengths stacked together. As shown in FIG. 3(b), which illustrates the upper part X of the light guide plate 300, the longest light pipe 300A is on the front, and a portion 500A thereof is covered by the diffusion surface 500, thereby serving to illuminate the LCD panel 100 in the area A. The second longest light pipe 300B is stacked on the light pipe 300A, and a portion 500B of the light pipe 300B is covered by the diffusion surface 500, thereby serving to illuminate the LCD panel 100 in the area B through the light pipe A. The shortest light pipe 300C is stacked on the light pipe 300B, and a portion 500C thereof is covered by the diffusion surface 500, thereby serving to illuminate the LCD panel 100 in the area C through the light pipes 300A and 300B. Moreover, as shown in FIG. 3(b), the diffusion surfaces 500 attached to the respective light pipes 300A to 300C are arranged without overlapping with each other. Also, in the first exemplary embodiment, the longest light pipe is the one closest to the light filter layer 200, and the shortest light pipe is the one farthest from the light filter layer 200.

As shown in FIG. 3(c), a light beam 600 emitted from the lamp 400B of the light source 400 is guided by the light pipe 300B and diffused at the portion 500B of the light pipe 300B, on which the diffusion surface 500 is attached. The light beam 600 diffused at the portion 500B of the light pipe 300B passes through the light pipe 300A and the light filter layer 200 to illuminate the LCD panel 100 in the area B (of FIG. 3(b)).

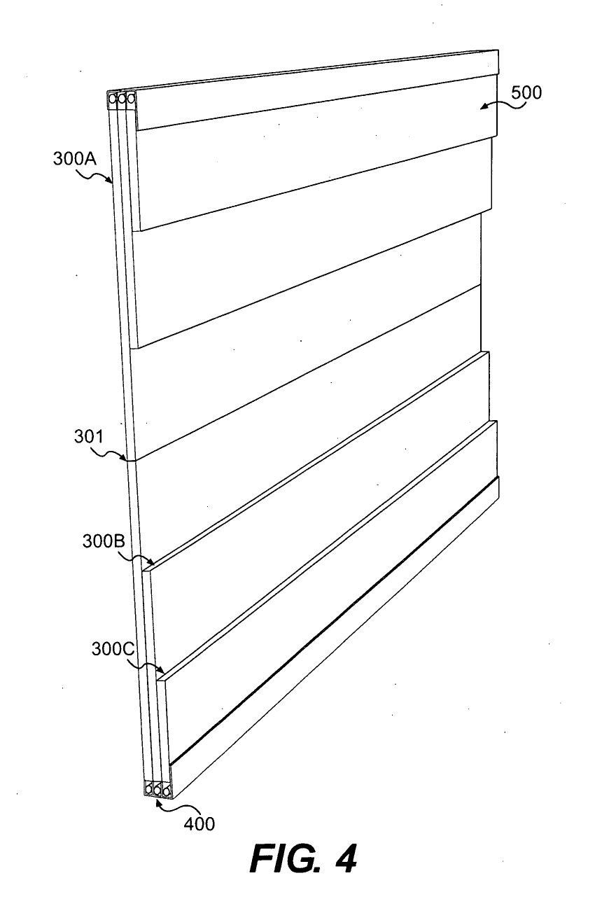

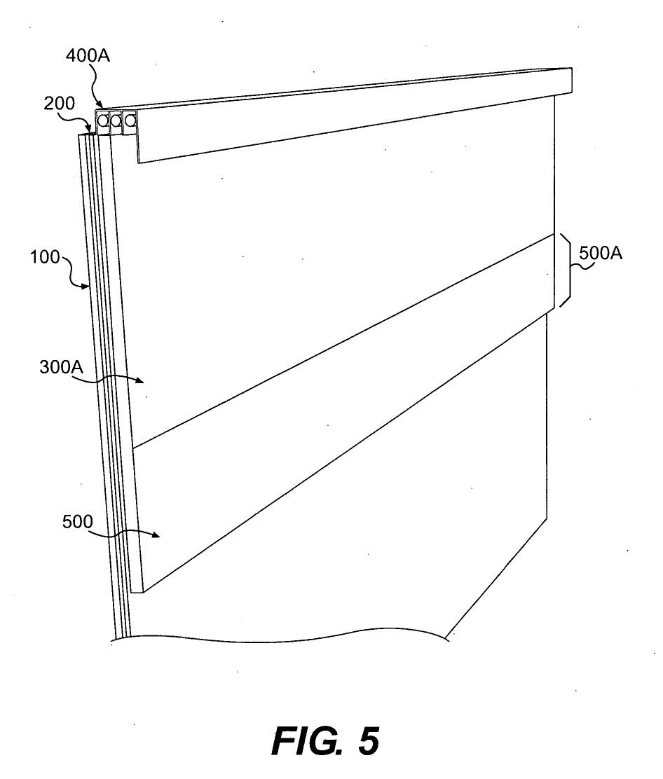

FIG. 4 is a view schematically illustrating a configuration of the light pipes 300A, 300B and 300C of the backlight assembly of the LCD device according to the first exemplary embodiment of the present invention. As shown in FIG. 4, the plurality of light pipes 300A, 300B and 300C are stacked up with different lengths, and are arranged to be symmetrical about the center of the LCD panel 100 or the center 301 of the longest light pipe 300A. FIG. 5 is a view schematically illustrating only the light pipe 300A of the backlight assembly of the LCD device according to the first embodiment of the present invention. As shown in FIG. 5, the light pipe 300A has the portion 500A covered by the diffusion surface 500, so that when the lamp 400A turns ON and emits light beams, the portion 500A serves to diffuse the light beams. Thus, the diffused light beams pass through the light filter layer 200 to illuminate the LCD panel 100 in the area A (of FIG. 3(b)).

According to the first exemplary embodiment, since the above-described arrangement can illuminate different areas of the screen of the LCD panel 100 independently by selective energization of the lamps 400A, 400B and 400C, the undesirable artifacts attached to the LCD panel 100 can be reduced or canceled. Also, when compared with the LCD device of the related art, less energy can be used because the light lamps 400B and 400C can be chosen with less power than the light lamp 400A-because the light lamps 400B and 400C illuminate smaller areas of the display than the light lamp 400A.

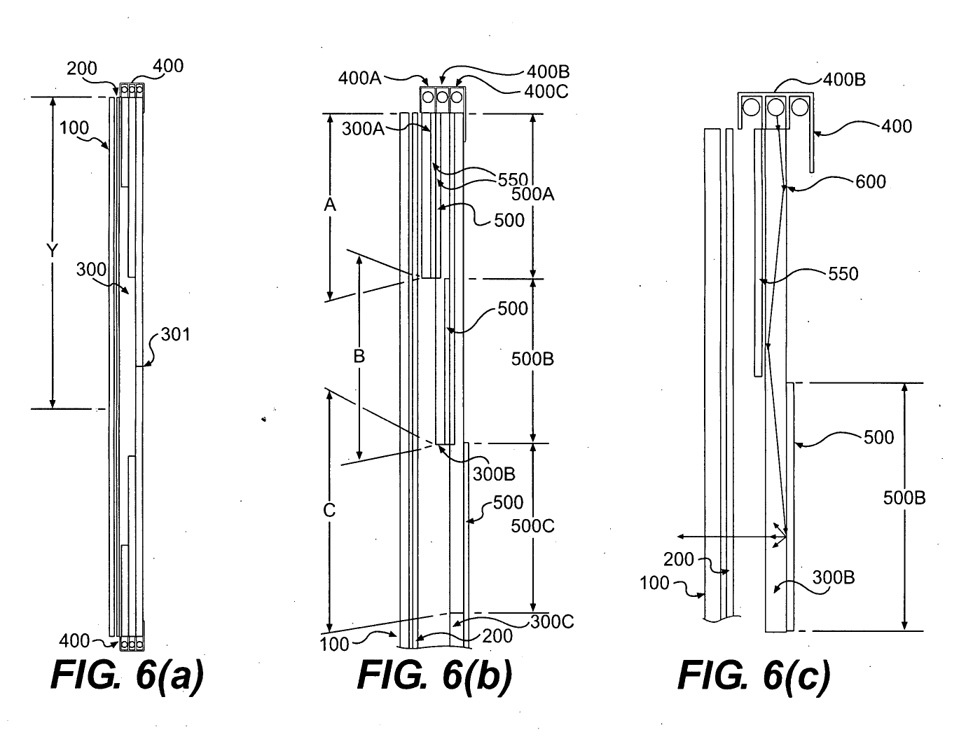

FIGS. 6(a) to 6(c) are cross-sectional views schematically illustrating an LCD device including a backlight assembly according to a second exemplary embodiment of the present invention. FIG. 6(a) is a cross-sectional view of the LCD device including the backlight assembly having a plurality of light pipes 300A, 300B and 300C with different configurations, FIG. 6(b) is a cross-sectional view illustrating a portion Y of the backlight assembly of FIG. 6(a), and FIG. 6(c) is a cross-sectional view illustrating one light pipe of the backlight assembly of the LCD device of FIG. 6(b).

Referring to FIGS. 6(a) to 6(c), the LCD device includes an LCD panel 100, a light filter layer 200 arranged behind the LCD panel 100, and the backlight assembly arranged behind the light filter layer 200. The backlight assembly includes a light guide plate 300 arranged behind the light filter layer 200, and a light source 400 arranged laterally at two sides of the light guide plate 300. The light guide plate 300 includes a plurality of light pipes, which are stacked up together, thereby forming the light guide plate 300. The light pipes may be made of a transparent plastic material. The light pipes may be designed to have different configurations. That is, the light pipes may be formed with different lengths, thicknesses and/or shapes depending on image contents to be displayed. The light source 400 includes a plurality of lamps. The plurality of lamps may be provided with different types and/or different powers depending on the image contents to be displayed.

As shown in FIG. 6(b), in this exemplary embodiment, there are three light pipes 300A, 300B and 300C, and three lamps 400A, 400B and 400C respectively associated with the light pipes 300A, 300B and 300C of the light guide plate 300. The light pipes 300A, 300B and 300C may be formed at least with different lengths. The lamps 400A, 400B and 400C may be provided at least with different powers with the lamp 400A being the lowest power and the lamp 400C being the highest power. Each of the light pipes 300A, 300B and 300C has a portion thereof covered by a diffusion surface 500. The diffusion surface 500 may be made of white paint, white line, or texture on the surface of the light pipe. The diffusion surface 500 may also be made of any other materials that allow the diffusion of light. Because each of the light pipes 300A, 300B and 300C has a portion of its rear surface covered by the diffusion surface 500, the covered portions serve to illuminate the LCD panel 100. Moreover, the diffusion surfaces 500 attached to the respective light pipes may be formed with different shapes and/or thicknesses, and are particularly arranged not to overlap one another.

In this second exemplary embodiment, as shown in FIG. 6(a), the light guide plate 300 includes an upper part and a lower part, which are symmetrical about the center of the LCD panel 100 or a center 301 of the light pipe 300C such that each of the upper and lower parts includes the light pipes 300A, 300B and 300C stacked up together with different lengths. As shown in FIG. 6(b), which illustrates the upper part Y of the light guide plate 300, the shortest light pipe 300A is on the front, and a portion 500A thereof is covered by a diffusion surface 500 to serve to illuminate the LCD panel 100 in the area A. The second light pipe 300B, which is longer than the light pipe 300A, is stacked on the light pipe 300A, and a portion 500B of the light pipe 300B is covered by a diffusion surface 500 to serve to illuminate the area B of the LCD panel 100. The longest light pipe 300C is stacked on the light pipe 300B, and a portion 500C thereof is covered by a diffusion surface 500 to serve to illuminate the area C of the LCD panel 100. In such an arrangement, the shortest light pipe is the one closest to the light filter layer 200, and the longest light pipe is the one farthest from the light filter layer 200. Thus, in the second exemplary embodiment, light coming from the portions 500A, 500B and 500C goes through only one light pipe before reaching the light filter layer 200. Moreover, as shown in FIG. 6(b), reflective coating layers (or a reflective sheet) 550 may be arranged among the light pipes 300A, 300B and 300C to avoid diffusion or light leaks. Each of the reflective coating layers is formed to cover a rear surface of its corresponding light pipe including the diffusion surface 500 attached to the corresponding light pipe.

As shown in FIG. 6(c), a light beam 600 emitted from the lamp 400B is guided by the light pipe 300B and diffused at the portion 500B of the light pipe 300B, on which the diffusion surface 500 is attached. The light beam 600 diffused at the portion B of the light pipe 300B passes through the light filter layer 200 to illuminate the LCD panel 100.

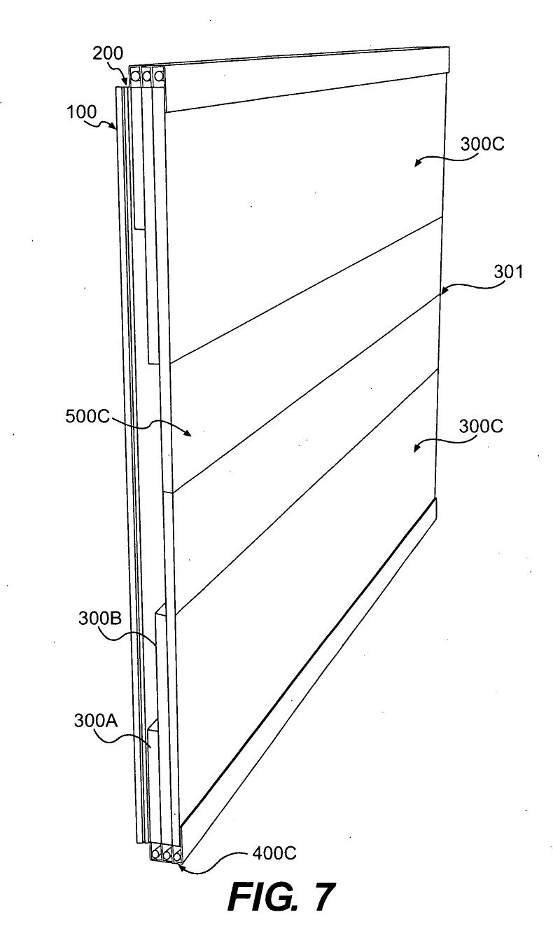

FIG. 7 is a view schematically illustrating the configuration of the light pipes 300A to 300C of the backlight assembly of the LCD device according to the second exemplary embodiment of the present invention. As shown in FIG. 7, in the backlight assembly of the second exemplary embodiment, the plurality of light pipes 300A, 300B and 300C are stacked up in the adverse order to those shown in FIG. 4 of the first exemplary embodiment, and are arranged to be symmetrical about the center 301 of the longest light pipe 300C. Also, the portion 500C of the light pipe 300C is covered by the diffusion surface 500, so that the light beams, which are emitted from the lamp 400C of the light source 400 and diffused by the diffusion surface 500 at the portion 500C, passes through the light filter layer 200 to illuminate the LCD panel 100 in the area C (of FIG. 6(b)).

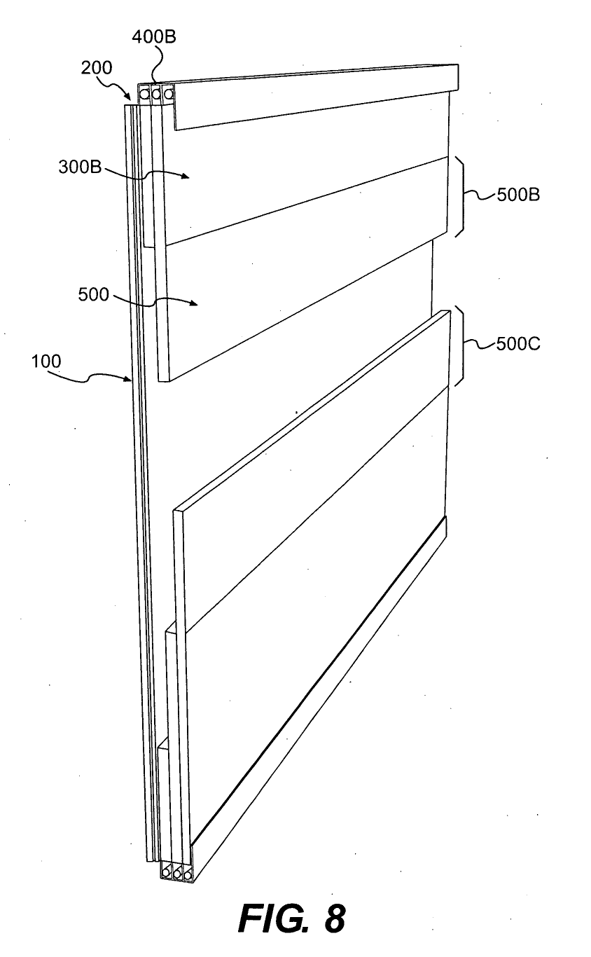

FIG. 8 is a view schematically illustrating a configuration in which the light pipe 300C of the upper part of the light guide plate is removed according to the second embodiment of the present invention. As shown in FIG. 8, the portions 500B of the light pipe 300B are covered by the diffusion surface 500, so that the light beams, which are emitted from the lamp 400B of the light source 400 and diffused by the diffusion surface 500 at the portion 500B, passes through the light filter layer 200 to illuminate the LCD panel 100 in the area B (of FIG. 6(b)).

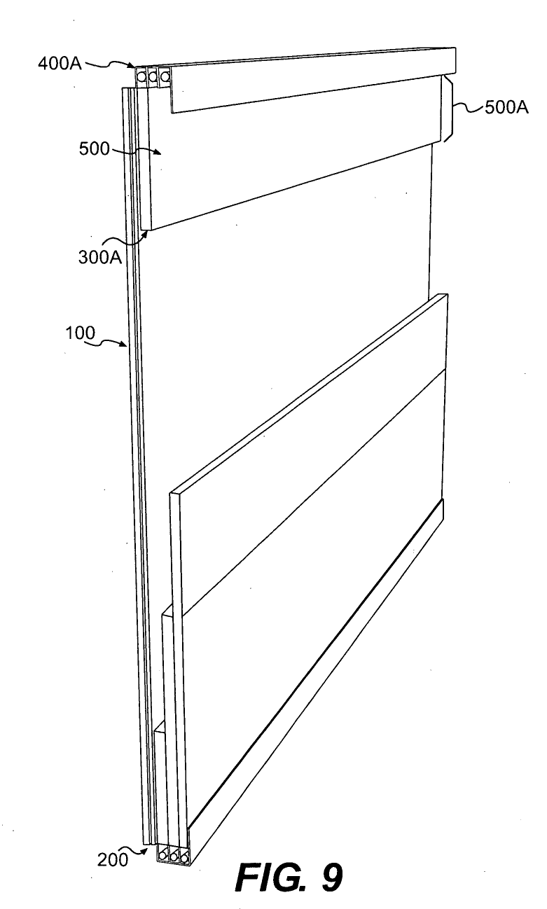

FIG. 9 is a view schematically illustrating a configuration in which the light pipes 300B and 300C of the upper part of the light guide plate are removed according to the second embodiment of the present invention. As shown in FIG. 9, the portion 500A of the light pipe 300A is covered by the diffusion surface 500, so that the light beams, which are emitted from the light source 400 and diffused by the diffusion surface 500 at the portion 500A, passes through the light filter layer 200 to illuminate the LCD panel 100 in the area A (of FIG. 6(b)).

According to the second exemplary embodiment, since the above-described arrangement is capable of illuminating different areas of the screen of the LCD panel 100 independently, the undesirable artifacts attached to the LCD panel 100 can be reduced or canceled by using the backlight assembly with different lighting configurations of the second exemplary embodiment. Also, energy consumption can be reduced by using the backlight assembly having lamps with different lighting powers for different areas of the screen of the LCD device depending on the image contents to be displayed.

It will be apparent to those skilled in the art that various modifications and variations can be made in the backlight assembly and the LCD device using the backlight assembly of the present invention without departing from the spirit or scope of the invention. Thus, it is intended that the present invention cover the modifications and variations of this invention provided they come within the scope of the appended claims and their equivalents.

What is claimed is:

1. A liquid crystal display (LCD) device, comprising:
an LCD panel having an exterior surface with a first area and an interior surface;
a light filter layer having an exterior surface provided at the interior surface of the LCD panel and an interior surface;
a light guide assembly provided behind the interior surface of the light filter layer, the light guide assembly including a plurality of light pipes;
a light source including a plurality of selectively illuminated lamps arranged at a lateral side of the light guide assembly, each of the lamps being respectively associated with a different one of the light pipes for emitting light into the respective light pipe;
a plurality of diffusion surfaces, each of the diffusion surfaces being provided on a selected area of a respective one of the plurality of the light pipes, the selected area being smaller than the first area;
wherein each of the diffusion surfaces causes light to be emitted from the selected area of the respective light pipe when the light pipe is illuminated by the lamp associated therewith.

2. The LCD device according to claim 1, wherein the plurality of light pipes are plate-like having a common width and different lengths.

3. The LCD device according to claim 2, wherein the plurality of light pipes are stacked up in such an order that the light pipe with the longest length is provided closest to the light filter layer and the light pipe with the shortest length is farthest from the light filter layer.

4. The LCD device according to claim 2, wherein the plurality of light pipes are stacked up in such an order that the light pipe with the shortest length is provided closest to the light filter layer and the light pipe longest length is provided farthest from the light filter layer.

5. The LCD device according to claim 4, further comprising a plurality of reflective coating layers that are formed between the plurality of light pipes to minimize the diffusion and leakage of light among the light pipes.

6. The LCD device according to claim 5, wherein each of the reflective coating layers is formed to cover a rear surface of a corresponding one of the plurality of the light pipes including the diffusion surface thereof.

7. The LCD device according to claim 1, wherein the plurality of diffusion surfaces do not overlap one another.

8. The LCD device according to claim 1, wherein the each of the diffusion surfaces is made of white paint, white lines, or texturing a surface of the light pipe.

9. The LCD device according to claim 1, wherein the plurality of diffusion surfaces are formed with different shapes.

10. The LCD device according to claim 1, wherein the plurality of lamps are provided with different powers.

11. A backlight assembly for a display panel, comprising:
a light guide assembly including a plurality of light pipes;
a light source arranged at a lateral side of the light guide assembly;
a plurality of diffusion surfaces, each of the diffusion surfaces being provided on a selected area of a respective one of the plurality of the light pipes;
wherein each of the diffusion surfaces causes light to be emitted from the selected area of the respective light pipe when the light pipe is illuminated by the light source.

12. The backlight assembly according to claim 11, wherein the light source includes a plurality of selectively illuminated lamps arranged at a lateral side of the light guide assembly, each of the lamps being respectively associated with a different one of the light pipes for emitting light into the respective light pipe.

13. The backlight assembly according to claim 11, wherein the light pipes are stacked together and have a common width and different lengths.

14. The backlight assembly according to claim 13, wherein the light guide assembly has a front face and a rear face, and wherein the plurality of light pipes are stacked in order such that the light pipe with the longest length is provided closest to the front face and the light pipe with the shortest length is provided closest to the rear face.

15. The backlight assembly according to claim 13, wherein the light guide assembly has a front face and a rear face, and wherein the plurality of light pipes are stacked in order such that the light pipe with the shortest length is provided closest to the front face and the light pipe with the longest length is provided closest to the rear face.

16. The backlight assembly according to claim 11, wherein each of the light pipes has a corresponding reflective coating layer formed between adjacent light pipes to minimize the diffusion and leakage of light among the light pipes.

17. The backlight assembly according to claim 16, wherein the reflective coating layer is formed to cover a rear surface of its corresponding light pipe including the diffusion surface provided thereon.

18. The backlight assembly according to claim 11, wherein the plurality of diffusion surfaces are attached to respective rear surfaces of the plurality of light pipes, and do not overlap each other.

19. The backlight assembly according to claim 11, wherein the diffusion surface is formed of white paint, white lines, or a textured surface.

20. The backlight assembly according to claim 19, wherein the plurality of diffusion surfaces are formed with different configurations.

21. The backlight assembly according to claim 12, wherein the plurality of lamps are provided with different powers.
